(19) United States
(12) Patent Application Publication
(10) Pub. No.: US 2002/0147767 A1
(43) Pub. Date: Oct. 10, 2002

(54) Buyer and seller revenue optimization

(75) Inventors: Tony J. Brice, Colleyville, TX (US); Gary J. Potter, Hurst, TX (US)

Correspondence Address: FINNEGAN, HENDERSON, FARABOW, GARRETT &, DUNNER LLP, 1300 I STREET, NW, WASHINGTON, DC, 20005, US

(73) Assignee: Sabre Inc.

(21) Appl. No.: 09/825,929

(22) Filed: Apr. 5, 2001

(51) Int. Cl. G06F 15/16

(52) U.S. Cl. 709/203

(57) ABSTRACT

Methods and systems consistent with the present invention allow access to inventory data stored in communication devices at remote locations on a network. The communication devices monitor the network for a real-time notification of a change in inventory data associated with another communication device. When the monitoring communication device detects a change in the inventory status from another communication device on the network, the monitoring communication device performs an inventory analysis. After completing the inventory analysis, a user operating the monitoring communication device decides whether an update in marketing strategy for an item should be implemented to maintain profitability.

### DESCRIPTION OF THE INVENTION

1. Field of the Invention

The present invention relates to data management and more particularly, to a system and method that allows suppliers to monitor changes in the status of the product inventory of a competitor.

2. Background of the Invention

Companies have tried for years to effectively monitor sales by their competitors and use the result of this work to adjust their own price and inventory accordingly. For example, when Company A determines that its competitor Company B has closed sale of an item at a particular price (because, for example, its inventory has been exhausted), Company A might increase its price for a competing item. Furthermore, Company A may indicate that its inventory for a competing item is sold out even if this is not true, or indicate that its inventory for the same item that Company B sold has been exhausted (even it this is not true). After indicating that its inventory is either sold-out or exhausted, Company A may then offer a higher-priced competing product. Any one of these options would maximize revenue for Company A in light of Company B's decision to close sale for the item.

Imperfect information on the sales of competitors, however, has made it difficult for companies to effectively monitor sales by their competitors and use the result of this work to adjust their own price and inventory accordingly. For example, a decision by Company A in the scenario outlined above to close its own sale for the same item that Company B sells and offer a higher-priced alternative could backfire on Company A if Company B decides to re-open sales for the previously closed item. Company A may not only lose the sales that it initially gained by Company B's initial decision but Company B may profit further by a loyalty factor if the item is one subject to repeat sales.

Accordingly, there is a need for a facility that enables companies to effectively monitor sales by their competitors and use the result of this work to adjust their own price and inventory accordingly.

### SUMMARY OF THE INVENTION

Accordingly, the present invention is directed to monitoring the inventory status of a competitor on a network in real-time and optimizing the adjustment of product marketing strategies based on competitor product data.

In accordance with the purpose of the invention, as embodied and broadly described, the invention provides a method of revenue optimization allowing a plurality of sellers to individually monitor a network for activity relating to an item. Using a monitoring process, when a seller receives a notification of a change in inventory status of the item of a competitor over the network in real-time, the seller evaluates a marketing strategy of a competing item based on the received change in inventory status using an inventory analysis method. Based upon the results of the inventory analysis, the seller updates the marketing strategy of the competing item.

In another aspect, the present invention includes a revenue optimization method for monitoring an inventory status on a network. The method permits at least one of a plurality of sellers to access an inventory status of at least one of a plurality of competitors. The seller is notified of the changes in the inventory status of the competitor in real-time. The seller evaluates the changes in the inventory status of the competitor using one of a plurality of inventory analysis methods. If the inventory analysis method indicates a desired result, the seller updates an inventory status.

In another aspect, the present invention includes a network connecting a plurality of competitors selling items, the network having an inventory control method comprising establishing a communication link to the network to monitor for changes in an inventory status from competitors. The method further allows detecting an inventory status change associated with an item from one of the competitors and determining whether to adjust a price on an inventory associated with a competing item based on the detected inventory status change. The determination is made when the competing item competes for sales with the item for which the inventory status change has been detected. The method further adjusts the price or inventory associated with the competing item based on a result of the determination.

In yet another aspect, the present invention includes a network connecting devices where each device is associated with one of a plurality of competitors selling items. Using an inventory control method, each competitor using a device automatically communicates to the network inventory status changes associated with items sold by that competitor. The inventory control method further enables each competitor using a device to detect an inventory status change associated with an item from one of its competitors and determine whether to adjust a price or an inventory associated with a competing item based on the detected inventory status change. The determination is made when the competing item competes for sales with the item for which the inventory status change has been detected. Each competitor adjusts the price or inventory associated with the competing item based on a result of the determination.

In another aspect of the invention, a system connects a plurality of communication devices in a network. Each communication device in the network comprises a monitoring means for real-time detection of an inventory status change for an item associated with at least one of the other communication devices on the network. Further, an analyzing means is used for evaluating an effect a change in inventory status of the item associated with the other communication device has on profits of a competing item. Each communication device also includes an adjusting means for adjusting at least one of a price or inventory of the competing item based on the evaluation.

In another aspect of the invention, the present invention includes in a network connecting a plurality of competitors selling items. The network having an inventory control method comprising establishing a communication link to the network to monitor for changes in an inventory status from competitors. The method further allows detecting an inventory status change associated with one of a set of items from one of the competitors and determining whether to adjust a price or inventory associated with a competing item based on the detected inventory status change. The determination is made when the competing items competes for sales with one of the set of items for which the inventory status change has been detected. The method further provides adjusting the price or inventory associated with the competing item based on a result of the determination.

Additional advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification and together with the description, serve to explain the principles of the invention. In the figures:

FIG. 1 illustrates the general structure of a system consistent with the present invention;

FIG. 2 illustrates the structure of a communication device consistent with the present invention;

FIG. 3 illustrates the active components of a communication method consistent with an implementation of the present invention; and

FIG. 4 shows a flow diagram illustrating the process of updating an inventory status consistent with the present invention.

### DETAILED DESCRIPTION

Reference will now be made in detail to an implementation of the present invention, an example of which is illustrated in the accompanying drawings. Wherever possible, the same reference numbers will be used throughout the drawings to refer to the same or like parts.

Systems consistent within the present invention allow access to inventory data stored in a plurality of communication devices on a network. The inventory data includes information detailing both the price and availability of items (e.g., products and services). Inventory data belonging to an entity and stored in one of the communication devices may be monitored over the network by a competitor using another communication device. When the communication device monitoring the network detects a change in the inventory status for the item, the communication device monitoring the network performs an inventory evaluation using an inventory analysis method. Once the evaluation is complete, the competitor may decide whether to change its marketing strategy to make its items more profitable.

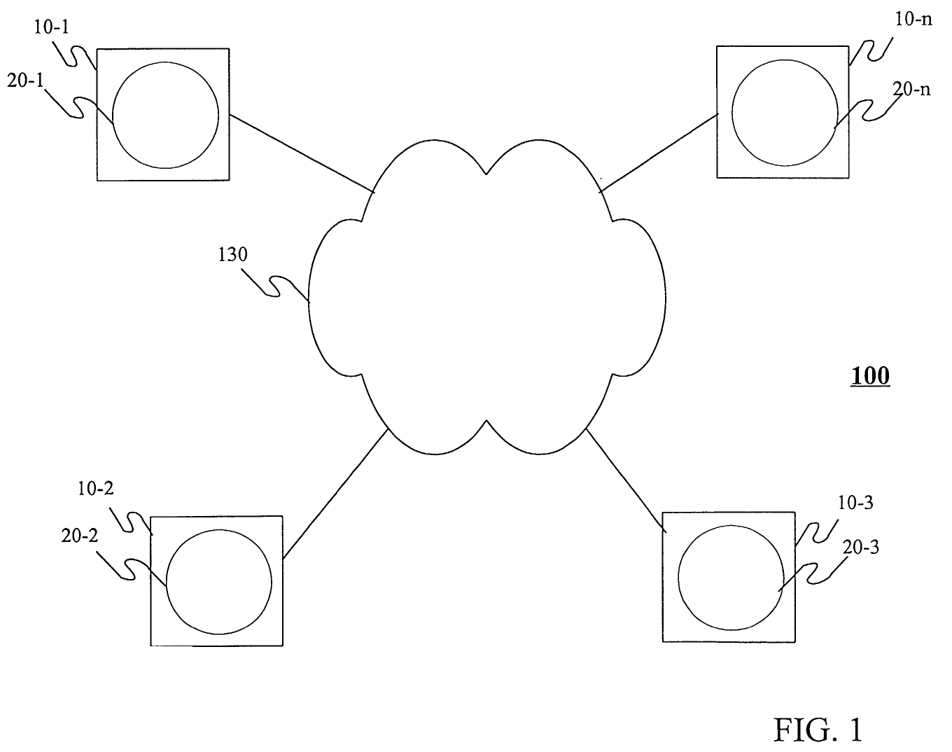

FIG. 1 is a block diagram illustrating the general structure of a revenue optimization system 100 in which buyer and seller revenue optimization is implemented in accordance with an embodiment of the present invention. In FIG. 1, system 100 includes a network 130 that connects a plurality of communication devices 10-1 through 10-n. Network 130 represents any network architecture that facilitates communication between communication devices 10-1 through 10-n. A plurality of network participants (users) 20-1 through 20-n operating at communication devices 10-1 through 10-n respectively, may individually evaluate the inventory status of competing items based on an inventory status change of an item marketed by another user on network 130.

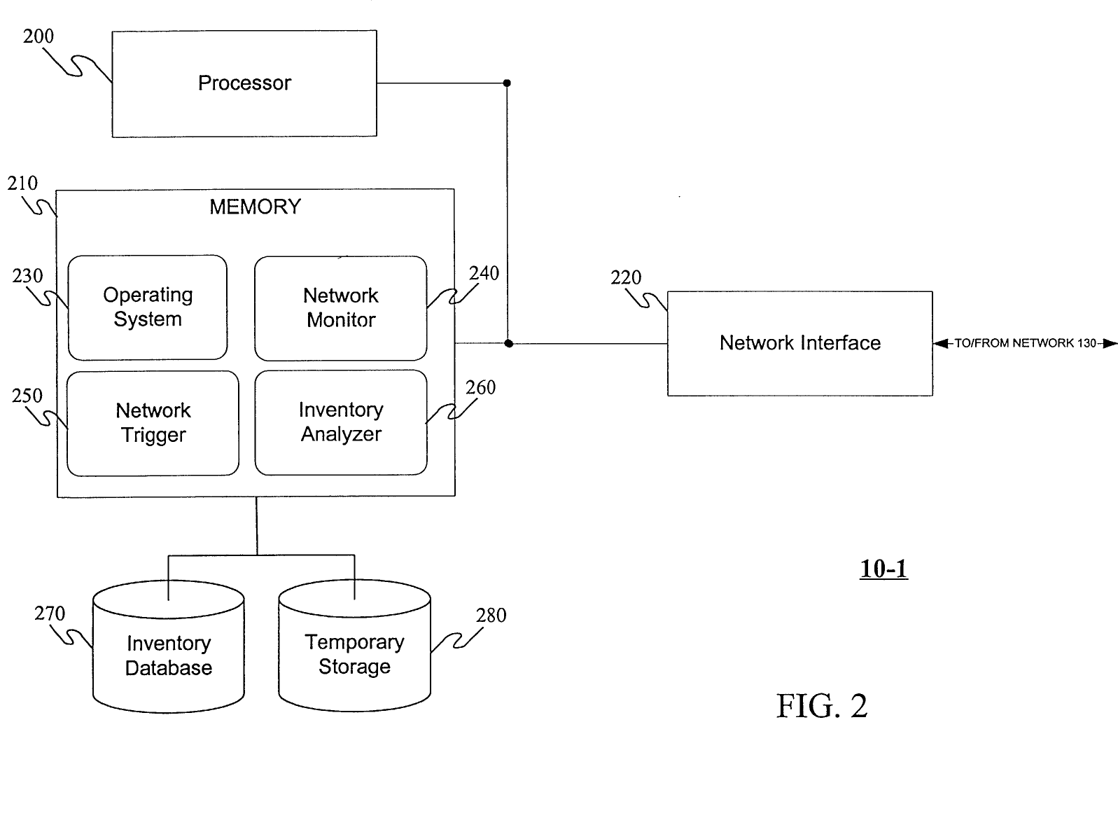

FIG. 2 is a block diagram of communication device 10-1, in accordance with an embodiment of the invention. Communication device 10-1 is representative of any one of communication devices 10-1 through 10-n, and includes a processor 200, a memory 210, a network interface 220, an inventory database 270, and temporary storage 280.

Processor 200 controls the operation of communication device 10-1 through 10-n, by implementing program instructions stored in memory 210.

Memory 210 stores software including program instructions that schedule tasks, manage storage, and handle communication over network 130. The software includes an operating system 230, a network monitor 240, a network trigger 250, and an inventory analyzer 260. Operating system 230 coordinates processing events executed by network monitor 240, network trigger 250, and inventory analyzer 260. Network monitor 240 “listens” to all activity on the network corresponding to inventory information of a competing item stored at a communication device of a competitor. A user operating at each communication device may configure a notification authorization with network 130 for that particular device, such that only notification information corresponding to a certain industry or item are received. Inventory analyzer 260 performs computations based on a change in the product inventory of a competitor and the current state of the inventory for an item stored in inventory database 270, discussed in detail below. Network trigger 250 notifies network 130 of any changes in the marketing status of items stored in inventory database 270. The notification signal may include data related to changes in the price of an item, changes in the inventory of an item, or changes in price and inventory of an item.

Inventory database 270 stores price and inventory data related to items marketed through communication device 10-1.

Temporary storage 280 stores, among other things, price and inventory data of other communication devices retrieved from network 130 through network interface 220.

Network interface 220 allows communication devices 10-1 to broadcast inventory status updates executed by network trigger 250 over network 130.

Each communication device 10-1 through 10-n may operate in a sending mode and/or a receiving mode. In the sending mode, the communication device identified as a sender, communicates notification of a change in inventory status to network 130, whereas in the receiving mode, the communication device identified as a receiver, evaluates the notification of the change in inventory status received from network 130.

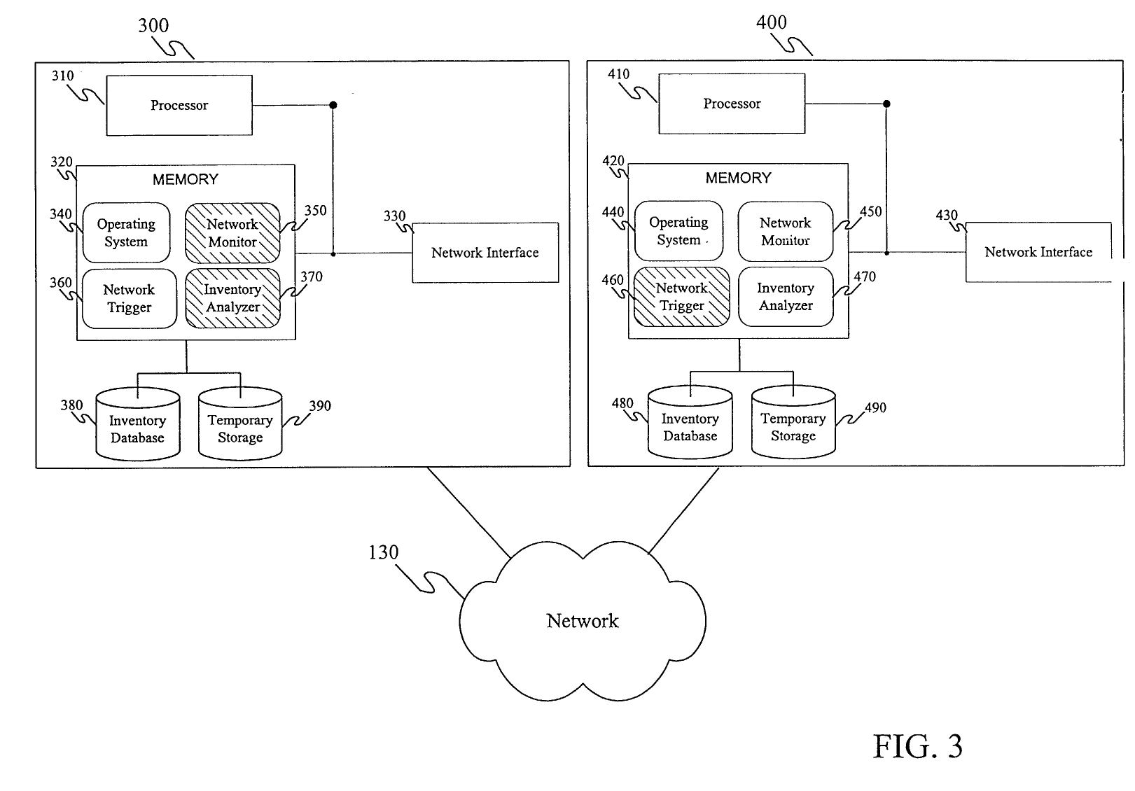

The communication device 10-1 shown in FIG. 2, contains both sender and receiver components. On the other hand, FIG. 3 shows the various components of a communication device in operation as a sender 300 and receiver 400.

In FIG. 3, communication devices 300 and 400 contain processors 310 and 410, memories 320 and 420, network interfaces 330 and 430, inventory databases 380 and 480, and temporary storage 390 and 490, respectively. The elements in communication devices 300 and 400 function in the same manner as similar elements described above in FIG. 2. In this example, communication device 300 initially operates as a sender, and processor 310 executes operating system 340 and network trigger 360. Network monitor 350 and inventory analyzer 370 are not active and are therefore presented in FIG. 3 as shaded. On the other hand, communication device 400 initially operates as a receiver, with processor 410 executing operating system 440, network monitor 450, and inventory analyzer 470. In this instance, network trigger 460 is not active and is therefore presented in FIG. 3 as shaded. Network interfaces 330 and 430, inventory databases 380 and 480, and temporary storage 390 and 490, respectively, are accessible by both communication devices 300 and 400, respectively.

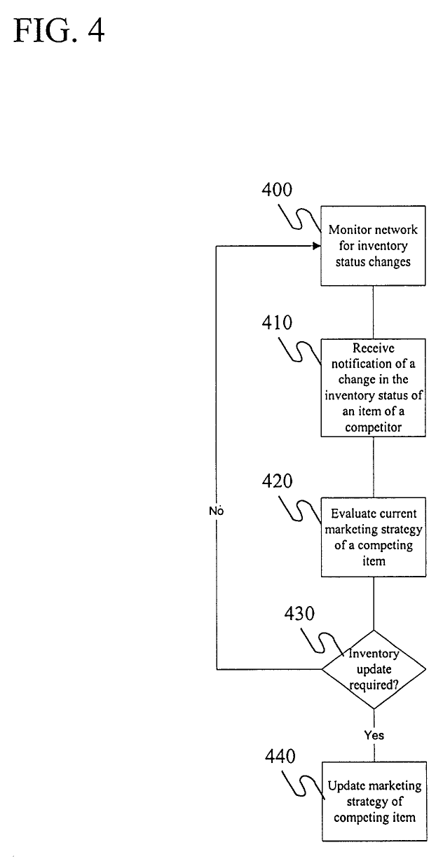

FIG. 4 is a flow chart illustrating the process of updating an inventory status of a competitor in accordance with an embodiment of the present invention. In this example, a user 20-3 operating communication device 300 updates the inventory status of an item stored in inventory database 380. As a result, network trigger 360 may notify the server (not shown) of network 130 in real-time regarding the change in inventory status of the item. The server then sends a real-time notification to those communication devices authorized to receive notification corresponding to the updated item. Network monitor 450 may then receive from the server of network 130, a real-time notification of the change in inventory status of the item of communication device 300 (step 400).

Once network monitor 450 receives notification, operating system 440 may direct network monitor 450 to store the notification information in temporary storage 490 (step 410). When network monitor 450 stores the notification information in temporary storage 490, inventory analyzer 470 may access the inventory information stored in temporary storage 480, to evaluate the effect on profits caused by the updated inventory status of the competing item (step 420). Inventory analyzer 470 evaluates the inventory status of the item by applying one of a plurality of inventory analysis methods. The inventory analysis method applied to the data by inventory analyzer 470 is predicated on the type of item and/or the industry under consideration. For example, products and devices in the travel industry are evaluated using a different inventory analysis method than products and services in the retail industry. Because these inventory analysis methods are well known to those within a particular industry, they will not be discussed in further detail. The results provided by the inventory analysis measure an increase or reduction in the value of an item of a seller due to the change in inventory status of the competing item of a competitor. Based on the results of the inventory analysis, a user 20-4 operating communication device 400 may determine whether updating the marketing strategy of the item stored in inventory database 480 is necessary to maintain profitability (step 430). This marketing strategy may include changes in item price, changes in the number of available items, a combination of both a change in price and change in availability of the item, or other parameters that may affect profitability of the item. If user 20-4 decides to update the marketing strategy of an item in inventory database 480, then communication device 400 may operate as a sender.

As a sender, the components of communication device 400 will remain the same as shown in FIG. 3, however, the active software modules will follow from those designated in communication device 300 (where active processes include operating system 440 and network trigger 460, and inactive processes include network monitor 450 and inventory analyzer 370). Network trigger 460, as described above regarding network trigger 360, notifies network 130 in real-time that a change in inventory status has occurred (step 440). Communication device 300 may now operate as a receiver (where active processes include operating system 440, network monitor 450, and inventory analyzer 470), and detect the inventory status update of communication device 400, thus repeating steps 400-440 of FIG. 4. On the other hand, if user 20-4 determines updating inventory database 480 is not necessary to maintain profitability, then processing returns to step 310 and network monitor 450 polls the server of network 130 for an inventory update notification.

An example of a scenario where a user updates the inventory status of a product based upon a change in the inventory status of a competitor is detailed below.

An airline A, participating on a network, closes the seat inventory for a $129 fare on a flight between Chicago and Denver for a specified date, and at a time of 9:00 AM. A competing airline B, participating on the same network on the specified date, markets an identical flight between Chicago and Denver. Airline B monitors the network for any inventory status events. When airline A closes the seat availability for the flight, the network notifies airline B of the inventory status change in real-time. Airline B receives the real-time notification information and stores the received data in temporary storage. The inventory analyzer of airline B then compares the inventory data of competing airline A stored in temporary storage with the inventory data of airline B stored in the inventory database. This comparison determines whether the inventory changes of the competing item of airline A have a negative impact on the item of airline B. Based on the analysis, airline B may either continue selling seats for this flight at $129 or close the fare to maximize revenues. In this example, Airline B decides to close the fare.

Likewise, when airline B closes the fare, the network trigger notifies the network of the change in inventory status of airline B in real-time. The inventory analyzer of airline A may now analyze the change in inventory status of airline B, by receiving the real-time notification information of airline B that corresponds to the change as discussed above. Airline A receives the real-time notification information and stores the received data in temporary storage. The inventory analyzer of airline A compares the inventory data of airline B stored in temporary storage with the inventory data of airline A stored in the inventory database. By this comparison, airline A determines whether the inventory changes of airline B have a negative impact on product profitability of airline A. Based on this analysis, airline A decides to re-open the remaining seats at a fare of $129.

Another scenario in which monitoring an inventory status may be used to evaluate product marketability is described below.

Airline A may have one hundred seats available on a flight between New York and Atlanta at a fare of $300. Airline A runs a promotion for a limited time and drops the price of fifty of the one hundred seats to $150. Because Airline A is a participant on a network, the network trigger notifies all other participants on the network of the change in fare of Airline A for the flight between New York and Atlanta in real-time. For example, after receiving the real-time inventory status change of Airline A and storing the product data in temporary storage, inventory analyzer of airline B re-evaluates the seat inventory for the same flight stored in the inventory database. After completing the evaluation, Airline B also may decide to drop the fare of some of the remaining seats. On the other hand, Airline B may decide to offer more frequent flyer miles for the flight between New York and Atlanta, or offer two free nights stay at a partnered hotel in either destination city. There are many other marketing options available to Airline B known to one of ordinary skill in the airline industry that will not be discussed here.

Although the examples above deal specifically with the airline industry, it is obvious to one of ordinary skill that the systems and methods described above may be used to monitor and evaluate the profitability for a variety of products and services in various industries.

In another scenario, a store A sells an item at a price of $500. However, due to reduced demand, store A decides to reduce the inventory and lower the price of the item to $400. As a participant on a network, when store A updates the inventory and price of the item a competing store B is notified of the update in real-time. The communication device of store B, retrieves real-time notification information corresponding to the updated item and stores the notification information in temporary storage. Based on the real-time notification information in temporary storage and the inventory data stored in the inventory database, the communication device of store B performs an inventory analysis. From the results of the inventory analysis store B determines that based on the changes in price and inventory made by store A, an update in the price and inventory of the competing item is not necessary maintain profitability.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A revenue optimization method allowing a plurality of sellers to individually monitor a network for activity relating to an item, wherein a monitoring process of one of the sellers comprises the following steps:
receiving notification of a change in inventory status of an item of a competitor over the network in real-time;
evaluating a marketing strategy of a competing item based on the received notification using an inventory analysis method; and
updating the marketing strategy of the competing item based upon a result of the inventory analysis.

2. The method of claim 1, wherein the inventory analysis method comprises:
measuring an increase or reduction in a value of the competing item based on the change in inventory status of the item of the competitor.

3. The method of claim 1, wherein evaluating a marketing strategy comprises:
determining an impact the change in inventory status of the item of the competitor has on profitability of the competing item.

4. A revenue optimization method of monitoring an inventory status on a network comprising the steps of:
permitting at least one of a plurality of sellers to access an inventory status of at least one of a plurality of competitors;
notifying the seller of changes in the inventory status of the competitor in real-time;
allowing the seller to evaluate the changes in the inventory status of the competitor using one of a plurality of inventory analysis methods; and
updating an inventory status for the seller if the inventory analysis method indicates a desired result.

5. In a network connecting a plurality of competitors selling items, an inventory control method comprising:
establishing a communication link to the network to monitor for changes in an inventory status from competitors;
detecting an inventory status change associated with an item from one of the competitors;
determining whether to adjust a price or an inventory associated with a competing item based on the detected inventory status change, wherein the competing item competes for sales with the item for which the inventory status change has been detected; and
adjusting the price or inventory associated with the competing item based on a result of the determination.

6. The method of claim 5 wherein adjusting the price or inventory further comprises:
measuring an increase or reduction in a value of the competing item of a seller based on the inventory status change of the item of the competitor.

7. In a network connecting devices, each device associated with one of a plurality of competitors selling items, an inventory control method comprising:
enabling each competitor using a device to automatically communicate to the network inventory status changes associated with items sold by that competitor; and
enabling each competitor using a device to
detect an inventory status change associated with an item from one of its competitors,
determine whether to adjust a price or an inventory associated with a competing item based on the detected inventory status change, wherein the competing item competes for sales with the item for which the inventory status change has been detected, and
adjust the price or inventory associated with the competing item based on a result of the determination.

8. A system connecting a plurality of communication devices in a network, each communication device comprising:
monitoring means for real-time detection of an inventory status change for an item associated with at least one other communication device on the network;
analyzing means for evaluating an effect a change in inventory status of the item associated with the other communication device has on profits of a competing item; and
adjusting means for adjusting at least one of a price or inventory of the competing item based on the evaluation.

9. The system of claim 8, wherein each communication device further comprises:
trigger means for notifying the network when an adjustment is made to at least one of the price or inventory of the competing item.

10. The system of claim 8, wherein each communication device further comprises:
memory means for storing a plurality of applications and a plurality of inventory information of at least one of the item or competing item.

11. In a network connecting a plurality of competitors selling items, an inventory control method comprising:
establishing a communication link to the network to monitor for changes in an inventory status from competitors;
detecting an inventory status change associated with one of a set of items from one of the competitors;
determining whether to adjust a price or an inventory associated with a competing item based on the detected inventory status change, wherein the competing item competes for sales with one of the set of items for which the inventory status change has been detected; and
adjusting the price or inventory associated with the competing item based on a result of the determination.
